(19) United States
(12) Patent Application Publication
(10) Pub. No.: US 2023/0303018 A1
(43) Pub. Date: Sep. 28, 2023

(54) MAIN SWITCH OF AN ELECTRICAL SYSTEM OF A VEHICLE

(71) Applicant: Ellenberger & Poensgen GmbH, Altdorf (DE)

(72) Inventors: Bernd BISCHOF, Reichenschwand (DE); Manuel ENGEWALD, Nuernberg (DE); Stefan HANNES, Neumarkt (DE); Markus MIKLIS, Schwarzenbruck (DE); Christian NEUBERT, Zirndorf-Weiherhof (DE); Matthias SCHWARZ, Burgthann (DE)

(73) Assignee: Ellenberger & Poensgen GmbH, Altdorf (DE)

(21) Appl. No.: 18/126,208

(22) Filed: Mar. 24, 2023

(30) Foreign Application Priority Data
Mar. 25, 2022 (DE) 10 2022 202 988.7

(51) Int. Cl. B60R 16/03; H02H 3/08; H02H 3/04; H02J 1/08

(52) U.S. Cl. CPC B60R 16/03; H02H 3/04; H02H 3/08; H02J 1/08; H02J 2310/40

(57) ABSTRACT

A main switch of an electrical system of a vehicle, in particular agricultural machinery, with a first main current path in which a first switch is introduced, and with a second main current path. The main switch comprises a control unit and the first main current path is associated with a first current sensor and the second main current path is associated with a second current sensor. By means of the control unit, the first switch is actuated as a function of a deviation from the electrical currents detected by the two current sensors.

This nonprovisional application claims priority under 35 U.S.C. § 119(a) to German Patent Application No. 10 2022 202 988.7, which was filed in Germany on Mar. 25, 2022, and which is herein incorporated by reference.

### BACKGROUND OF THE INVENTION

### Field of the Invention

The invention relates to a main switch of an electrical system of a vehicle. The vehicle is in particular land-based and, for example, a commercial vehicle or preferably agricultural machinery.

### Description of the Background Art

Vehicles usually have a number of auxiliary units operated by means of an electric motor. Such an auxiliary unit is, if the vehicle is, for example, an agricultural machine or construction machine, a hydraulic system by means of which other actuators are driven. In other words, the auxiliary unit is used to perform a specific function of the vehicle. Also, other auxiliary units are usually available, which serve the comfort of the user of the vehicle, such as seat heating or a fan heater. If the vehicle is designed as an agricultural machine, it is also possible to conduct electrical energy directly from it by means of a cable to a coupled trailer that has an auxiliary unit. The auxiliary unit is operated directly by means of electrical energy, which is why losses are reduced.

The electrical energy required for operation is usually provided by means of a battery which, depending on the design, has a DC voltage of 12 V, 24 V or 48 V. The battery is powered by a generator which is powered by an internal combustion engine of the vehicle. If a comparatively large amount of electrical energy is required to operate the auxiliary unit, and this is only to be operated when the vehicle is operated, i.e., when the combustion engine is operated, it is possible to omit the battery or to power the auxiliary unit directly with the generator. Thus, production costs and the required installation space are reduced. In order to reduce weight and production costs, 48 V direct current is generally used for power supply. Thus, the electrical currents conducted with the respective cables are reduced. However, due to the increased electrical voltage, a risk to persons and / or other components cannot be excluded. In order to ensure that the respective auxiliary unit is not always operated at the beginning of operation of the internal combustion engine, it is necessary to insert a main switch into the line between the generator and the auxiliary unit, by means of which an energy flow between the generator and the auxiliary unit can be interrupted.

### SUMMARY OF THE INVENTION

It is therefore an object of the invention is to provide a particularly suitable main switch of a vehicle, wherein in particular safety is increased and assembly is simplified.

The main switch can be part of an electrical system of a vehicle. In other words, the main switch can be installed in the electrical system of a vehicle in the assembled state. The main switch is suitable, in particular provided and configured, for this purpose. The vehicle is movable and therefore mobile. Particularly preferably, the vehicle is a motor vehicle which is conveniently land-based. For this purpose, the motor vehicle has in particular a number of wheels which are powered by means of a drive. The motor vehicle is preferably not rail-bound and has, for example, a number of controllable wheels by means of which a direction of movement of the motor vehicle can be set. The motor vehicle is in particular an agricultural machine, such as a tractor, i.e., an agricultural traction vehicle, a combine harvester, a planting machine, or a fertilizer spreader. Alternatively, the motor vehicle is in particular a construction machine, such as an excavator, a front loader, a dump truck, a side tipper, a forklift, or any other commercial vehicle, such as a truck or a bus. Alternatively, the motor vehicle can be, for example, a passenger car. In another alternative, the vehicle is, for example, an airplane or a boat.

The vehicle electrical system is used in particular to carry electrical energy. For this purpose, the vehicle electrical system in the assembled state expediently extends between an electrical energy source of the vehicle, such as a battery or preferably a generator, and an auxiliary unit. In other words, the electrical energy required for the operation of the auxiliary unit is at least partially supplied by means of the vehicle electrical system. The auxiliary unit is, for example, a component of the vehicle and in particular an auxiliary unit which is not used in particular to propel the vehicle, but instead to perform another function. For example, the auxiliary unit serves to increase the comfort of the driver of the vehicle. Particularly preferably, however, a certain function is performed by means of the auxiliary unit for which the vehicle is intended, in particular if the vehicle is an agricultural or construction machine. For example, the auxiliary unit may be a hydraulic pump by means of which a hydraulic circuit is driven.

Alternatively, the auxiliary unit can be a component of a trailer which is coupled to the vehicle. The vehicle electrical system includes in particular a cable which is disposed, for example, on the vehicle body and extends to the trailer. Alternatively, for example, the cable is plugged into a corresponding plug of the vehicle electrical network.

By means of the vehicle electrical system, an electrical DC voltage is conveniently conducted during operation. The (electrical) DC voltage is, for example, 12 V or 24 V. Particularly preferably, however, the electrical DC voltage is 48 V. The main switch is used to interrupt an electrical current flow via the electrical system, in particular to interrupt the transmission of electrical energy. Preferably, the main switch is suitable due to the fact that an electrical voltage of 48 V or at least the electrical voltage conducted by means of the electrical system is applied.

Preferably, the main switch is suitable, in particular provided and configured, to carry a direct current. Preferably, the main switch is suitable, conveniently provided and configured, to carry an electric current of a maximum between 100 A and 1,000 A or between 200 A and 500 A. In this way, it is also possible to energize a comparatively powerful unit by means of the vehicle electrical system.

The main switch has a first main current path and a second main current path. Between the two main current paths, when the vehicle is being operated, there is in particular an electrical voltage of the vehicle electrical system, which is preferably provided by means of the generator or the battery. In particular, there is thus an electrical DC voltage between the two main current paths, preferably 48 V. By means of each of the main current paths, an electric current of up to 200 A or 250 A or 100 A is suitably conducted during operation, preferably in nominal operation. In particular, each main current path in the vehicle electrical system is arranged in such a way that it is electrically connected directly downstream of the generator or battery, i.e., the electrical energy source, so that the main switch serves in particular as a safety mechanism. In other words, no other component is electrically arranged electrically between the main switch and the electrical energy source, except, for example, a line or the like, through which only the conduction of electrical energy takes place. If there is nevertheless a component between these, this is expediently a fuse.

The main switch has a first switch inserted into the first main current path. The first switch is designed to be switchable, and it is therefore possible, depending on the setting, to use it to close or disconnect the first main current path. In other words, it is possible to transfer the first switch, and thus also the first main current path, to the electrically conductive or the electrically non-conductive state. The first switch is, for example, a relay or a semiconductor switch, preferably a field-effect transistor, such as a MOSFET, GTO, or IGBT. Alternatively, the first switch comprises, for example, one or more such semiconductor switches and / or a relay, which are preferably suitably interconnected, for example electrically in series or parallel. Thus, it is particularly possible to prevent the formation of a possible arc when opening the first switch or at least to shorten its duration, wherein an electrical resistance in the electrically conductive state of the first switch is comparatively low. The remaining components of the first main current path are formed, for example, by means of a respective busbar, which extend in particular on both sides of the first switch. Preferably, the first switch is designed such that by means of which a galvanic isolation of the first main current path is possible.

The main switch also includes a control unit. The control unit comprises, for example, a plurality of electrical and / or electronic components which are suitably interconnected so that a circuit is realized. The first switch is operated by means of the control unit. For example, a signal for a drive is created by means of the control unit, by means of which the first switch is actuated. Alternatively, the first switch has the corresponding drive, which is actuated as a function of the corresponding signal. In another alternative, the control unit comprises the drive, and the actuation of the first switch comprises, for example, a mechanical actuation or a current or the presence of a certain electrical voltage at the first switch.

Via the main switch, it is thus possible to interrupt a transmission of electrical energy via the vehicle electrical system and consequently to start or stop a current supply of any electrically connected auxiliary units. For example, the first switch can be operated manually, and the main switch comprises, for example, a lever which is mechanically or electrically coupled to the first switch, for example via the control unit.

The main switch further comprises a first current sensor associated with the first current path. For example, the first current sensor is introduced into the first main current path, so that by means of which at least temporarily the electric current conducted by means of the first main current path is also conducted. For example, the first current sensor is designed in the manner of a shunt. Alternatively, the first current sensor is only in active connection with the first main current path, wherein the first current sensor, for example, is separated from the first main current path and, for example, spaced from this. In this way, safety is increased. Conveniently, the first current sensor for this purpose comprises a magnetic field sensor, for example a Hall sensor.

By means of the first current sensor, measurement data are generated during operation, which characterize the electrical current conducted by means of the first main current path. For this purpose, the first current sensor is suitable, preferably provided and configured. In particular, an evaluation of these measurement data is carried out by means of the control unit, so that by means of the first current sensor and the control unit, the electric current conducted by means of the first main current path is detectable.

A second current sensor of the main switch is assigned to the second main current path. The second current sensor is, for example, designed in the manner of a shunt and / or comprises a magnetic field sensor. The second current sensor, for example, is identical to the first current sensor, so that identical parts can be used. Alternatively, the second current sensor is designed differently to this and has, for example, a different design, so that adaptation to the respective requirements is improved. It is at least possible by means of the second current sensor, in particular with the aid of the control unit, to detect the electric current conducted by means of the second main current path. For this purpose, corresponding measurement data are conveniently generated during operation by means of the second current sensor, which are suitably evaluated by means of the control unit.

The first and / or second current sensor are, for example, coupled by signals and / or electrically to the control unit. Preferably, the two current sensors are operated by means of the control unit and are preferably suitably connected to the control unit.

By means of the control unit, the first switch is actuated as a function of a deviation of the electrical currents detected by the two current sensors. In particular, the first switch is opened by means of the control unit if the difference between the two (electrical) currents, i.e., the deviation between them, is greater than a certain limit value. The limit is, for example, absolute and for example 0.1 A, 0.5 A or 1 A. Alternatively, the limit can be, for example, 10%, 5%, 2% or 1% of the electric current conducted by means of the first or second main current path.

The control unit is provided and configured for this action. For example, the control unit is correspondingly connected to the current sensors and the first switch, and / or the control unit has corresponding algorithms or routines. In particular, the control unit comprises a microprocessor, which is programmable, for example. Preferably, the control unit comprises a computer program product comprising a plurality of commands which, when the program is executed by the microprocessor, cause a signal to be emitted by means of which the first switch is opened when the deviation is greater than the limit value.

The electrical currents conducted by means of the two main current paths differ if leakage current is present in the vehicle electrical system, i.e., if, for example, a line of the electrical system or a current carrying part of the unit is connected via a short circuit to ground or, for example, to another vehicle electrical system, i.e., if there is a ground fault, for example of the vehicle electrical system or the auxiliary unit. Since the first switch is actuated in this case, the current supply and thus also the leakage current is interrupted, which increases safety. In addition, a malfunction and / or further damage to the auxiliary unit is excluded in this way. Only the installation of the main switch is required, simplifying installation.

The first switch can also be actuated by means of the control unit if the electric current conducted by means of the first or second main current path is above a respective further limit value. In the event of a short circuit, for example, comparatively high electrical currents occur. Due to the actuation of the first switch in this case, the current supply and thus also the short circuit is terminated, which is why a malfunction is also prevented here. In addition, thermal overload is prevented in this way. For example, the two current sensors are designed in such a way that the electrical current conducted with the assigned main current path can be detected by means of each. Alternatively, the two current sensors form a unit and are interconnected in such a way that only the residual current, i.e., the deviation of the electrical currents conducted by means of the two main current paths, can be detected.

The main switch can also comprises a voltage sensor which, for example, is switched between the first main current path and ground or the second main current path and ground or particularly preferably between the two main current paths. Preferably, the first switch is actuated by means of the control unit, also as a function of the respective recorded electrical voltage. In particular, the first switch is opened if the recorded electrical voltage exceeds a certain assigned limit value or falls below a certain critical limit value, which occurs, for example, in the event of a short circuit of the two main current paths. Thus, safety is further increased. Preferably, the main switch comprises two such voltage sensors, wherein the first switch is located between them. Thus, it is possible to check the actual switching state of the first switch on the basis of the recorded electrical voltage.

For example, the main switch may be formed only of the first switch, the two main current paths and the control unit. Particularly preferably, however, the main switch has further components, so that the range of functions is increased. Only the installation of the main switch is required, which again simplifies assembly.

In particular, the main switch comprises a pre-charging circuit by means of which the first switch is bridged. In particular, the pre-charging circuit is operated with the control unit, or the pre-charging circuit comprises a separate control unit. In particular, the pre-charging circuit, regardless of the concrete design of the respective control unit, is operated in such a way that before switching on the first switch, an electrical voltage dropping via this is reduced. For this purpose, the pre-charging circuit comprises in particular another switch, which is designed for example mechanically and / or electrically, and which comprises, for example, different switching units, such as a relay and / or semiconductor switch. With the further switch, in particular, a resistor of the pre-charging circuit is electrically connected in series.

For example, if the main switch is to be closed, the further switch is electrically current carrying until an electrical voltage arising via the (still open) first switch falls below a certain value, for example 1 V, 0.5 V or 0 V. For this purpose, the pre-charging circuit is, for example, operated time-controlled or as a function of the electrical voltage generated by the first switch, which is detected, for example, by means of a corresponding sensor. Only when the electrical voltage generated by the first switch falls below the certain value, which is, for example, 1 V, is the first switch closed. Thus, due to the pre-charging circuit, voltage peaks and / or current peaks in the vehicle electrical system are avoided when switching on the main switch, which could, for example, lead to damage to the electrically connected component, such as an electrical switch, or to the welding of a mechanical switch.

Alternatively, or in combination, the main switch comprises a discharge circuit that is routed against one of the main current paths. In this case, the discharge circuit is located in particular on the side of the first switch facing away from the electrical energy source. The discharge circuit conveniently comprises a further switch comprising, for example, one or more switching units, such as relays or semiconductor switches which are suitably interconnected. To the further switch, in particular, a resistor of the discharge circuit is electrically connected in series.

After opening the first switch, the electrical energy remaining in the vehicle electrical system is dissipated by means of the discharge circuit. For this purpose, in particular, the further switch is closed and thus the main current path is routed to a further electrical potential, such as ground, via the further switch and preferably the resistor. Thus, after opening the main switch, at least after a certain period of time, no further electrical energy is available in the vehicle electrical system or at least in the auxiliary units connected to it, so that safety is increased. For example, the discharge circuit is routed against the second main current path or against the first main current path. Particularly preferably, the two main current paths are connected to each other by means of the discharge circuit, so that when the further switch is actuated, the two main current paths are short-circuited. Preferably, the discharge circuit is operated by means of the control unit or a separate control unit. Preferably, after actuation of the first switch, so that this is opened, the discharge circuit is also actuated by means of the control unit, so that in particular the further switch is closed.

The second main current path can be electrically guided to ground, so that when opening the first switch, in particular on the vehicle electrical system, there is still an electrical potential, namely ground. For example, only the first switch is available for interrupting the electrical energy flow, so that a single pole disconnection takes place. Thus, it is possible to guide the auxiliary unit operated by means of the vehicle electrical system specifically to ground and thus to transfer it to a certain state, which increases safety.

Alternatively, a second switch can be introduced in the second main current path, which is operated by means of the control unit. The second switch, for example, is identical to the first switch or different from it. In particular, the second switch is formed by means of a relay or at least comprises this. Alternatively, or in combination, the second switch comprises a semiconductor switch, in particular a field effect transistor. The semiconductor switch and the relay are, if available, particularly suitably interconnected, for example electrically parallel and / or in series.

In particular, the second switch can be actuated when the first switch is also actuated. In other words, the second switch is also actuated as a function of the deviation of the electrical currents detected by the two current sensors. Due to the second switch, a two-pole disconnection of the vehicle electrical system takes place in particular, increasing safety. For example, the two switches are operated simultaneously. Alternatively, the second switch is actuated after the first switch has already been activated, or if there is a malfunction of the first switch. Due to the second switch, the vehicle electrical system or at least the auxiliary unit supplied with it is safely disconnected from the vehicle’s electrical energy source, further increasing safety. In another alternative, for example, the two switches are assigned different limit values, and these are only actuated when the respective assigned limit value is exceeded.

For example, the control unit can be energized via one of the main current paths, preferably both. In particular, a DC-DC converter is connected between the main current paths and the control unit. Particularly preferably, however, the main switch has a further power connection, via which the control unit is energized. The control unit is thus electrically contacted in particular with the further power connection and correspondingly connected to this. In particular, a secondary vehicle electrical system of the vehicle is connected to the further power connection in the assembled state and can therefore be connected there. The secondary electrical system is suitably galvanically isolated from the electrical system or at least has a different voltage level. Preferably, in the assembled state, the possible battery of the vehicle is connected to the further power connection, whereas the two main current paths of the main switch are electrically connected directly to the possible generator of the vehicle. Preferably, a lower amount of energy is conducted by means of the secondary vehicle electrical system than by means of the vehicle electrical system.

Preferably, an electrical DC voltage of 12 V or 24 V can be conducted by means of the secondary vehicle electrical system, provided that 48 V is conducted by means of the vehicle electrical system. Thus, the dielectric strength of the components required for the realization of the control unit is reduced, reducing manufacturing costs. Preferably, the first switch is designed in such a way that it can only be transferred into the electrically conductive state when the control unit is energized. Thus, for example, in the event of a failure of the secondary vehicle electrical system, the vehicle electrical system is also interrupted, increasing safety.

For example, the control unit can be energized by means of the electrical voltage applied to the further power connection. Particularly preferably, however, a direct current converter is connected between the further power connection and the control unit. The direct current converter, which is also referred to as a DC-DC converter, is used in particular to stabilize the electrical voltage applied to the control unit. Alternatively, or in combination, the DC-DC converter serves to reduce the electrical voltage present at the further current connection to a lower voltage level, by means of which the control unit is operated, such as 5 V. In this way, the required dielectric strength of the control unit is further reduced, reducing manufacturing costs.

In particular, the DC-DC converter can be operated only in certain states of the vehicle, so that the control unit is also operated only then. Preferably, operation takes place when an ignition of the vehicle is actuated, or this is at least set to a certain operating state. For this purpose, the DC-DC converter is conveniently connected accordingly and, for example, charged with a corresponding input, in particular the so-called terminal 15. In this way, the energy requirement of the main switch is reduced and leakage currents are avoided.

Particularly preferably, the main switch can have a data interface which is connected to the control unit by a signal. In other words, the data interface and the control unit are interconnected. The data interface is, for example, analog or preferably digital. Preferably, the data interface comprises a capacitor by means of which the applied voltage / signals are stabilized. In particular, the data interface corresponds to a certain standard, preferably a bus system. Suitably, a CAN, LIN, Ethernet, or SENT bus system is used as the bus system. Preferably, a client control unit (formerly “slave” control unit) of the bus system is realized in the assembled state by means of the control unit in conjunction with the data interface. In an alternative, the control unit acts as a master control unit. Alternatively, or in combination, the data interface includes a USB port or other serial port. Suitably, the data interface includes more such ports, enhancing flexibility.

In particular, prompts and / or commands are received during operation via the data interface, in particular for actuating the first and / or possible second switch. Preferably, the control unit is operated in such a way that the requests / commands are received and or processed. Conveniently, the control unit is operated in such a way that data is output via the data interface, such as the measured electrical currents and / or any electrical voltages. Alternatively, or in combination, error states or other states of the main switch are transmitted via the data interface. Due to the data interface, it is thus possible, for example, to operate the first switch by means of an on-board computer of the vehicle and / or to evaluate the data recorded by means of the main switch, further increasing a range of functions. Suitably, the data interface is mechanically integrated with a possible further power connection in a common plug, further simplifying the installation of the main switch.

Conveniently, the main switch can comprise a housing within which the first switch is arranged. Thus, the first switch is protected by means of the housing. If the second switch, the pre-charging circuit and / or the discharge circuit are present, these are also conveniently arranged within the housing. In addition, the control unit and the current sensors are arranged in the housing, so that the level of robustness is further increased.

The two main current paths extend between two ports each. For example, the ports are also arranged within the housing, so that they are mechanically protected by means of the housing. Particularly preferably, however, the ports are arranged outside the housing, and the housing comprises in particular a plurality of openings, wherein through each of the opening a portion of at least one of the main current paths is led. Preferably, the housing has four openings. In particular, each main current path comprises at least one busbar that is routed through the respective opening. Particularly preferably, each opening is designed fluid-tight, so that ingress of foreign particles into the housing is prevented.

The ports are, for example, designed in such a way that a cable lug or the like can be connected to each of them. For this purpose, each of the ports is formed, for example, by means of a flat conductor into which a (screw) bolt is pressed or welded to it. Alternatively, each of the ports can be formed as a plug, so that a corresponding mating plug of the vehicle electrical system can also be plugged in for electrical contact. For example, two of the mating plugs are each held by means of a common plug housing, which facilitates assembly. Particularly preferably, the main switch has an interlock system. In this case, one or more auxiliary ports are assigned to each of the two ports, which are electrically contacted in the assembled state with auxiliary mating plugs, which are also held on the plug housing. By means of the auxiliary ports / auxiliary mating plugs, only a comparatively low current is conducted and / or a comparatively low voltage is applied to these. When the plug housing is detached, the auxiliary mating plugs are first disconnected from the auxiliary ports, even before the ports are disconnected from the mating plugs. As soon as the detachment of the auxiliary ports is detected, the first switch is actuated by means of the control unit, so that there is no more electrical voltage at the ports, protecting any persons present. Alternatively, or in combination, a warning is issued so that persons in the vicinity of the main switch are alerted to a detachment of the mating plug.

For example, the housing can be made of aluminum. In this way, the dissipation of heat generated within the housing is simplified. Preferably, the housing is designed at least in sections according to the type of a heat sink and thus has at least in part cooling fins on the outside, which are in particular one-piece with other components. Thus, the dissipation of heat is further simplified, wherein the housing is fluid tight. Alternatively, the housing is at least partially made of plastic, which reduces weight and manufacturing costs. Suitably, the housing has a cutout in which a heat sink made of an aluminum or other metal is inserted. Thus, dissipation of excess heat is still possible.

In particular, the housing has a box-like base body, which is closed with a lid. In this way, it is possible to manufacture the housing and the other components of the main switch separately. Also, in this way, for example, maintenance and / or replacement of components is possible. Conveniently, a seal is present between the base body and the lid, which is, for example, a lamellar or foam seal. Alternatively, the seal is designed as a spray seal, or the lid is peripherally glued to the base body or provided with a fabric. In this way, despite the multi-part design of the housing, ingress of foreign particles into the housing is avoided. The housing or at least the base body is, for example, made of a plastic or metal, such as an aluminum, i.e., pure aluminum or an aluminum alloy.

Conveniently, the housing comprises a plurality of tabs, which are attached, suitably molded, in particular to the possible base body. By means of the tabs, mounting of the housing on other components of the vehicle is simplified. In particular, each tab has an opening through which a mounting screw for attachment to other components of the vehicle can be routed, and which are also arranged there in the assembled state. Suitably, a compression force limiter is provided for each of the tabs, for example a metal sleeve which is inserted into the respective opening. By means of this, it is ensured in particular that a preload applied during screwing is maintained. Therefore, the strength of the mounting screw is ensured and maintained. Protection against damage is achieved in particular by means of a suitable coordination between the metal sleeve and the housing.

The box-like base body can have a recess. In particular, the recess is open on the edge side. A plastic body is inserted into the recess, by means of which, in particular, the recess is completely filled. Preferably, the plastic body is glued to the base body, which increases tightness and the level of robustness. For example, the plastic body is made of an electrotechnical plastic such as PBT or polyamide. For example, the plastic body has a seal on the edge, or a seal is attached to it, which is made of a rubber, for example. The plastic body and / or any rubber seal are created, for example, by injection molding. By means of the seal, the transition between the plastic body and the edge of the recess is filled, so that in the assembled state the plastic body is fluid-tightly connected to the base body. Thus, despite the recess, ingress of particles into the housing is avoided. In particular, the plastic body forms at least part of the wall of the housing.

The ports of the first main current path can be attached to the plastic body. In particular, any associated busbars extend through the plastic body, so that by means of the plastic body, the ports are electrically led into the interior of the housing. Expediently, the plastic body comprises an insulating shield which is arranged between the ports. By means of the insulating shield, an unintentional short circuit when connecting cables to the ports is avoided. In addition, the first switch is attached to the plastic body. Thus, a module is provided which comprises the plastic body, the ports, the first switch and any busbars, and is preferably formed with them. Thus, mounting of the first switch as well as the ports on the housing is possible in one step. In the event of a defect in the first switch, replacement of the module is possible, wherein, with the exception of the ports of the first switch to the control unit, essentially no further activities are carried out, so that the replacement can also be carried out independently of a workshop. It is also possible to adapt the main switch to the desired application by replacing the respective module. In summary, modularization is possible and manufacturing costs are reduced.

If the second switch is present, the housing preferably has a second recess in which a second plastic body is inserted. The second switch and the assigned ports are attached to this. Preferably, the second switch is a component of a corresponding module which is identical to the module having the first switch. In this way, identical parts can be used, which simplifies storage and reduces manufacturing costs.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is schematically, a vehicle with a main switch;

FIG. 2 is a block diagram of the main switch;

FIG. 3 is in perspective, the main switch in an exploded view, which comprises two modules;

FIG. 4 is in perspective, one of the modules comprising a first switch;

FIG. 5 is the main switch, in perspective, in a rear view;

FIGS. 6, 7 are in perspective, in a front or rear view, an alternative embodiment of the main switch.

### DETAILED DESCRIPTION

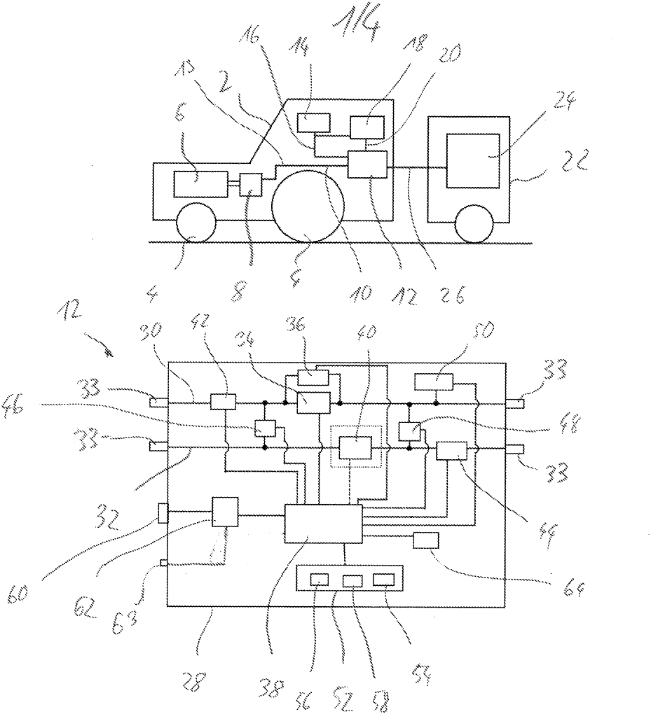

FIG. 1 shows a vehicle 2 in the form of an agricultural machine, namely a tractor, i.e., a traction machine, schematically simplified. The vehicle 2 comprises a plurality of wheels 4, at least some of which are driven by means of an internal combustion engine 6 via an unspecified transmission. By means of the internal combustion engine 6, a generator 8 is also driven, by means of which a vehicle electrical system 10 is supplied with electrical energy. For this purpose, an electrical DC voltage of 48 V is fed into the vehicle electrical system 10 by means of the generator 8. The vehicle electrical system 10 comprises a main switch 12, which is connected directly downstream of the generator 8. In other words, between the generator 8 and the main switch 12, with the exception of a connecting line 13, no other components of the vehicle electrical system 10 are arranged. Also, no other components are contacted there with the vehicle electrical system 10.

The vehicle 2 further comprises a battery 14, by means of which a secondary electrical system 16 is supplied. By means of the battery 14, an electrical DC voltage of 12 V is provided, which is thus routed by means of the secondary vehicle electrical system 16. The battery 14 is charged on demand when operated by means of the generator 8 via an unspecified DC-DC converter. With the secondary vehicle electrical system 16, the main switch 12 and an on-board computer 18 are energized. The on-board computer 18 and the main switch 12 are signally connected by means of a bus system 20, so that it is possible to exchange data / signals between the on-board computer 18 and the main switch 12.

A trailer 22 is coupled to the vehicle 2 and detachably connected to it. The trailer 22 carries an auxiliary unit 24, which is energized by means of the vehicle electrical system 10. For this purpose, the auxiliary unit 24 has an unspecified plug, which is electrically connected to a line 26 of the vehicle electrical system 10 downstream of the main switch 12. By means of the auxiliary unit 24, a certain function is performed during operation. For example, the trailer 22 is a planting machine, and by means of the auxiliary unit 24, seedlings are placed in suitably positioned guides.

FIG. 2 shows a schematically simplified circuit diagram of the main switch 12. The main switch 12 comprises a housing 28 through which a first main current path 30 and a second main current path 32 extend. Each main current path 30, 32 is associated with two ports 33, which are arranged outside the housing 28 and between which the main current paths 30, 32 extend. In this case, each main current path 30, 32 or each port 33 is routed through corresponding openings of the housing 28.

One of the ports 33 of the first main current path 30 and one of the ports 33 of the second main current path 32 are directly connected to the connecting line 13 leading to the generator 8. The remaining ports 33, however, are electrically contacted with the line 26, which is thus connected to them.

In the first main current path 30, a first switch 34 is introduced, which is designed as a relay. In this case, it is possible to carry and to switch an electric current of 250 A by means of the first switch 34, wherein an electrical voltage applied to the first switch 34 may be 48 V. By means of the first switch 34, it is possible to interrupt a current flow via the first main current path 30, namely by opening the first switch 34. When the first switch 34 is closed, on the other hand, a current flows via the first main current path 30. The first switch 34 is bridged with a pre-charging circuit 36, which comprises an unspecified further switch, which is preferably a relay or alternatively a semiconductor switch, and which is connected in series with a resistor.

The first switch 34 and the pre-charging circuit 36, i.e., the further switch, are operated by means of a control unit 38 and consequently actuated. In this case, the electrical energy required for switching the first switch 34 and the further switch 36 is provided by means of the control unit 38 during operation and a corresponding switching voltage is applied to the respective switches for this purpose.

In the second main current path 32, a second switch 40, which is structurally identical to the first switch 34, is introduced in at least some embodiments of the invention. The second switch 40, if present, is also actuated by means of the control unit 38. Thus, it is possible by means of the second switch 40 to also separate the second main current path 32, so that a current flow over this is interrupted. The main current path 32 is electrically guided to ground in an unspecified manner.

With the control unit 38, further a first current sensor 42 and a second current sensor 44 are operated, which are identical to each other and each designed as a shunt. Herein, the first current sensor 42 is associated with the first main current path 30, and the second current sensor 44 is associated with the second main current path 32. During operation, measurement data are generated by means of the two current sensors 42, 44, which are read out by means of the control unit 38. In this case, the electric current conducted with each of the main current paths 30, 32 is detected by means of the two current sensors 42, 44 and the control unit 38. If a deviation between the electrical currents detected by the two current sensors 42, 44 is greater than a limit value of 0.5 A, the first switch 34 is opened so that a current flow over the first main current path 30 is prevented. Such a difference occurs, for example, if there is a ground fault of the line 26 or a malfunction of the auxiliary unit 24, which leads to leakage currents. In this case, further damage to the auxiliary unit 24 or the environment of the vehicle 2 and the trailer 22 is thus avoided by actuating the first switch 34. In addition to the first switch 34, the second switch 40 is also actuated so that there is no electrical voltage present at all on the line 26. In an unspecified variant, the two current sensors 42.44 are realized by means of a common unit, namely as a residual current sensor.

If the auxiliary unit 24 is to be operated, the second switch 40 is first closed. Before the first switch 34 is transferred to the electrically conductive state, the pre-charging circuit 36 is first actuated, namely the further switch. Thus, an electric current flows first via the pre-charging circuit 36, which is limited due to the resistance of the pre-charging circuit 36. The electrical voltage applied to the terminals 33 facing the line 26 is also limited, so that current peaks in the vehicle electrical system 10 are avoided. Only when the electrical voltage generated via the first switch 34 falls below a certain limit is the first switch 34 closed and then the further switch is opened, so that the pre-charging circuit 36 is no longer current bearing. Thus, no electrical losses occur in the pre-charging circuit 36, and the electrical resistance of the first main current path 30 is comparatively low.

To determine the electrical voltage applied via the first switch 34, the main switch 12 comprises a first voltage sensor 46 and a second voltage sensor 48, by means of which the electrical voltage applied between the two main current paths 30, 32 can be measured. Between the two voltage sensors 46, 48 are the first switch 34 and the second switch 40. The two voltage sensors 46, 48 are signally connected to the control unit 38.

In addition to determining the applied electrical voltage via the first switch 34, the first switch 34, and optionally the second switch 40, is actuated on the basis of the respective electrical voltage detected by means of the voltage sensors 46, 48 and the control unit 38. If, for example, the electrical voltage detected by the second voltage sensor 48 decreases, which is the case with a short circuit of the auxiliary unit 24, the first switch 34 and the second switch 40 are also actuated, which prevents a further malfunction.

The main switch 12 further comprises a discharge circuit 50, which is routed on the side of the first switch 34 facing the line 26 against the first main current path 30. The discharge circuit 50 has a resistor and a further switch, which are electrically connected in series. The remaining end of the discharge circuit 50 is electrically guided to ground. In an unspecified variant, the discharge circuit 50 is connected between the two main current paths 30, 32, wherein the discharge circuit 50 is located on the side of the first switch 34 and the second switch 40 facing away from the generator 8. If there is a malfunction, for example due to too large a deviation of the detected electrical currents or a certain applied electrical voltage, or if a certain condition is present, so that the first switch 34 and the second switch 40 are opened, the discharge circuit 50 is actuated. In this case, the further switch is closed so that the first main current path 30 is electrically guided to ground. Thus, after opening the first switch 34, ground is present at the auxiliary unit 24 as an electrical potential, which is why a safe separation of the trailer 22 is possible and troubleshooting is facilitated.

The main switch 12 further comprises a data interface 52 comprising a USB port 54, an analog port 56, and a digital port 58. The bus system 20 is connected to the digital port 58. During operation, state data are provided by means of the control unit 38 via the data interface 52, so that, for example, from the on-board computer 18, the current state of the two switches 34, 40 can be retrieved. Also, via the data interface 52, the data acquired by means of the sensors 42, 44, 46, 48 are provided, so that they can be stored, for example, on a drive connected to the USB port 54. In addition, it is possible to forward commands to the control unit 38 via the data interface 52, as a function of which the switches 34, 40 are opened or closed. Thus, it is possible to influence the current supply of the auxiliary unit 24 by means of the on-board computer 18.

The control unit 38 is energized via a further power port 60, which is electrically contacted with the secondary vehicle electrical system 16. Here, a DC-DC converter 62 is connected between the further power port 60 and the control unit 38. By means of the DC-DC converter 62, the electrical DC voltage provided at the further power port 60 is reduced from 12 V to an electrical DC voltage of 5 V. Due to the current supply via the secondary vehicle electrical system 16, the required dielectric strength of the DC-DC converter 62 is reduced.

The DC-DC converter 62 is connected to an ignition of the vehicle 2 via a further port 63. In other words, the further port 63 corresponds to the terminal 15. In this case, the DC-DC converter 62 is operated only if there is a level at the further port 63. Thus, the electrical voltage is provided by means of the DC-DC converter 62 only when the ignition is switched on, and only then is the control unit 38 operated. Thus, the energy requirement is reduced.

The first switch 34 and also the second switch 40 are designed in such a way that these are in the electrically conductive state only when a corresponding signal is applied by means of the control unit 38. In other words, the switches 34, 40 are monostable. Unless such a signal is created with the control unit 38 / such an electrical voltage is applied, the first switch 34 and the second switch 40 are in the open state. Thus, in the event of a failure of the control unit 38, or even if the ignition is switched off, operation of the components connected to the line 26, such as the auxiliary unit 24, is not possible, which increases safety.

The main switch 12 further comprises an interlock system 64, which is at least partially operated with the control unit 38. The interlock system 64 comprises a plurality of unspecified auxiliary ports, which are electrically connected to corresponding auxiliary mating plugs of the line 26. The electrical currents conducted with the auxiliary ports / auxiliary mating plugs amount to a few milliamperes, wherein the applied electrical voltage is below 50 V. When detaching the line 26 from the main switch 12, first the auxiliary ports are disconnected from the auxiliary mating plugs due to the geometric design, wherein the ports 33 are still electrically connected to the assigned mating plugs of the line 26. If the detachment of the auxiliary ports from the auxiliary mating plugs is detected, the first switch 34 and the second switch 40 are opened, so that electrical voltage is no longer present at the ports 33, which are assigned to the line 26. If, therefore, the line 26 is subsequently completely detached, there is no danger when a person touches the main switch 12 or components of the vehicle electrical system 10 connected downstream.

FIG. 3 shows a first embodiment of the main switch 12 in a perspective exploded view. The housing 28 has a box-like base body 66 which is made of an aluminum, and which is shown in FIG. 4 in perspective from the back. At the bottom of the box or pot-like base body 66, several cooling fins 67 are formed on the outside, so that the base body 66 is partially designed in the manner of a heat sink.

The base body 66 is sealed fluid-tight in the assembled state by means of a flat lid 68, also made of aluminum, wherein between these there is an unspecified seal. In an unspecified variant, the sealing effect is realized by means of an adhesive. Within the base body 66, the control unit 38 is arranged, which is attached to a circuit board or comprises this. Also attached to the circuit board are the pre-charging circuit 36 and the discharge circuit 50 and the sensors 42, 44, 46, 48 as well as other components of the main switch 12 arranged within the housing 28.

On the outside of the base body 66, outwardly facing tabs 70 are formed, which serve to attach the main switch 12 to other components of the vehicle 2. For this purpose, the tabs 70 each have an opening 72, within which corresponding mounting screws are arranged in the assembled state. In addition, the opening 70 is lined by means of an unspecified compression force limiter, which is provided by means of a metal sleeve.

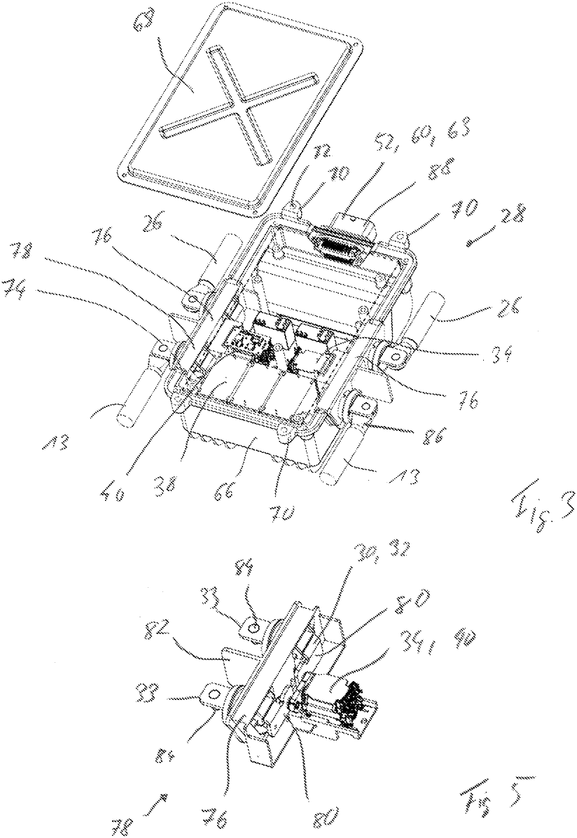

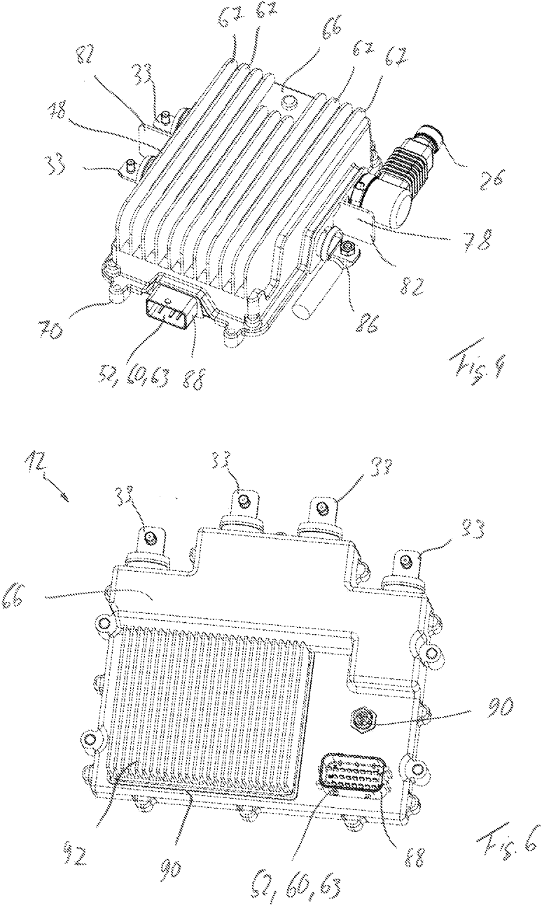

On opposite (edge) sides, the base body 66 has open recesses 74 on each edge side, which are completely filled by means of a respective plastic body 76. Each plastic body 76 is a component of one of two identical modules 78, one of which is shown enlarged in perspective in FIG. 5. Here, by means of one of the modules 78, the first switch 34 is provided, and by means of the remaining one, the second switch 40. On the plastic body 76 of the respective module 78, the first or second switch 34, 40 is attached, wherein the switches 34, 40 are located on the side of the plastic body 76 facing the inside of the housing. On the opposite side of the plastic body 76, the ports 33 assigned to the respective switch 34, 40 are attached to it, which merge into a respective busbar 80 of the respective main current path 30, 32. Between the two ports 33, a platelet-shaped insulating body 82 of the plastic body 76 is arranged, which is why an unintentional short circuit between the two ports 33 is avoided when connected to other components.

The busbars 80 are overmolded with the plastic of the plastic body 76, so that the module 78 is designed fluid tight. In an unspecified variant, the busbars 80 are additionally encapsulated with a sealant. With the busbars protruding through the plastic body 76, the respective switch 34, 40 is electrically contacted. Each port 33 is formed by means of a flat conductor, which is one-piece with the respective busbar 80, and into which a bolt 84 is pressed, to which a cable lug 86 of the connecting line 13 or the line 26 can be connected.

A plug 88 is attached to the base body 66, which is partially made of a plastic. In the plug 88, the data interface 52, the further power port 60 and the further port 63 are integrated. Thus, assembly of the main switch 12 is simplified.

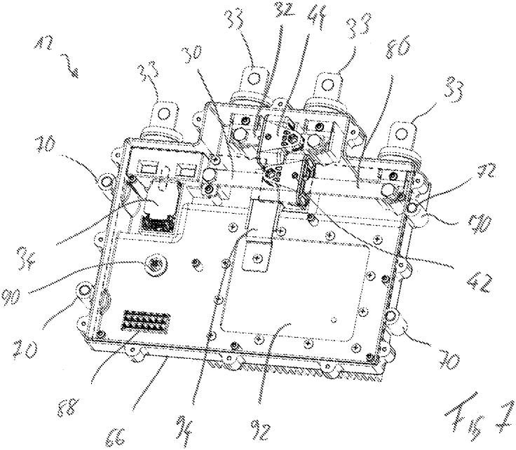

FIG. 6 shows an alternative embodiment of the main switch 12 in a front view and FIG. 7 in a rear view. Here, too, the main switch 12 comprises the housing 28 having the box-like or shell-like base body 66, which is closed with the lid 68, but which is not shown in FIG. 7. The box-like base body 66 is made of a plastic in this embodiment, as well as the lid not shown in more detail.

The box-like base body 66 has a rectangular cutout 90 at its bottom, in which a heat sink 92 made of an aluminum is inserted. During production, the heat sink 92 is overmolded circumferentially by means of the plastic of the base body 66, so that a fluid tight connection is created between them. In a further alternative, the heat sink 92 is tightly joined with the base body 66 using a seal and / or bond. The heat sink 92 is thermally connected via an electrically insulating thermal bridge 94 and optionally a thermal paste with components arranged in the base body 66, so that during operation a heat dissipation of these takes place. Also in this variant, the tabs 70 are formed on the base body 66 with the openings 72, within each of which one of the compression force limiters is arranged.

In this embodiment, the modules 78 are not present, but instead the similarly designed ports 33, which are arranged parallel to each other, reach directly into the base body 66 and have also been overmolded with the plastic of the base body 66 during production, so that a fluid tight connection takes place. In an unspecified variant, the sealant is additionally present, by means of which the ports 33 are potted. The ports 33 assigned to the second main current path 32 are directly electrically contacted with each other by means of one of the busbars 80, so that only a single-pole disconnection is possible in this embodiment. In other words, the second switch 40 is not present.

The remaining ports 33, in this embodiment the outer ones, are connected to each other by means of corresponding busbars 80 via the first switch 34, which is operated by means of the control unit 38 not shown herein. Here, too, the plug 88 is present, which, however, is partially formed by means of the base body 66. In this case, the plug 88 is located at the bottom of the base body 66, and by means of the plug 88, both the data interface 52, the further power port 60 and the further port 63 are provided. In addition, a further plug 90 is available, which is also inserted into the bottom of the base body 66, and into which other components can be plugged if necessary, such as a capacitor. Due to the external connection of the capacitor, replacement, for example in the event of damage, is facilitated.

The invention is not limited to the embodiments described above. Rather, other variants of the invention can be derived therefrom by the skilled person without departing from the subject-matter of the invention. In particular, all the individual features described in connection with the individual embodiments can also be combined in other ways without departing from the subject-matter of the invention.

The invention being thus described, it will be obvious that the same may be varied in many ways. Such variations are not to be regarded as a departure from the spirit and scope of the invention and all such modifications as would be obvious to one skilled in the art to be included within the scope of the following claims.

What is claimed is:

1. A main switch of an electrical system of a vehicle), in particular agricultural machinery, the main switch comprising:
a first main current path, in which a first switch is introduced;
a second main current path; and
a control unit,
wherein the first main current path is associated with a first current sensor and the second main current path is associated with a second current sensor, and
wherein, via the control unit, the first switch is actuated as a function of a deviation of electric currents detected by the two current sensors.

2. The main switch according to claim 1, wherein the first switch is bridged by a precharging circuit.

3. The main switch according to claim 1, further comprising a discharge circuit, which is routed against one of the main current paths.

4. The main switch according to claim 1, wherein, in the second main current path, a second switch is introduced, which is operated by means of the control unit.

5. The main switch according to claim 1, further comprising a further power port via which the control unit is energized.

6. The main switch according to claim 5, wherein, between the further power port and the control unit, a DC-DC converter is connected.

7. The main switch according to claim 1, further comprising a data interface, which is signally connected to the control unit.

8. The main switch according to claim 1, further comprising a housing within which the first switch, the control unit and the current sensors are arranged, and wherein the two main current paths extend between two ports, which are located outside the housing.

9. The main switch according to claim 8, wherein the housing comprises a box-like base body with a recess in which a plastic body is inserted, to which the ports of the first main current path and the first switch are attached.
